(19) United States
(12) Patent Application Publication
(10) Pub. No.: US 2012/0169759 A1
(43) Pub. Date: Jul. 5, 2012

(54) METHOD AND APPARATUS FOR CREATING A LIVE ARTISTIC SKETCH OF AN IMAGE

(75) Inventors: Mahesh Mohan PATIL, Bangalore (IN); Sumukh Rama Avadhani, Bangalore (IN); Anju Kalakkandathil, Bangalore (IN); Raghavendra Kalose Mathsyendranath, Bangalore (IN)

(73) Assignee: Samsung Electronics Co., Ltd., Suwon-si (KR)

(21) Appl. No.: 13/343,518

(22) Filed: Jan. 4, 2012

(30) Foreign Application Priority Data
Jan. 4, 2011 (IN) 17/CHE/2011

(51) Int. Cl. G06T 11/20; G09G 5/02

(52) U.S. Cl. 345/594; 345/441

(57) ABSTRACT

A method for sketching and painting in a mobile terminal includes determining, when an image for sketching is selected, edges of the selected image, determining a type of a sketch mode and depicting a sketching process with the detected edges to correspond to the determined type of the sketch mode, and determining, upon a painting request for an image sketched through the sketching process, a painting mode and painting the sketched image to correspond to the determined painting mode.

### PRIORITY

This application claims priority under 35 U.S.C. §119(a) to an Indian Provisional Patent Application filed in the Indian Patent Office on Jan. 4, 2011 and assigned Serial No. 17/CHE/2011, the contents of which are incorporated herein by reference.

### BACKGROUND OF THE INVENTION

1. Field of the Invention

The present invention relates generally to image processing, and more particularly, to a method for sketching an image in real time and/or automatically and painting the sketched image on a mobile terminal.

2. Description of the Related Art

A sketch refers to a freehand drawing that is not usually intended as a finished work. A sketch may serve a number of purposes: it might record something that the artist sees, it might record or develop an idea for later use or it might be used as a quick way of graphically demonstrating an image, idea or principle.

Sketches are routinely drawn by a human artist to represent an object or a scene on a paper. For example, the human artist may paint or draw a picture based on an original scene in a manner that is based on the creative and abstract judgment of the artist. Generally, the artist develops a sketch/painting in a sequential process. The process involves an inherent knowledge of knowing what to sketch/paint first, then deciding what to sketch/paint next and so on.

Currently, various image processing applications known for generating sketch effect of an image. One of the existing applications enables a user to create a pencil/pen sketch from an image while another existing application use a number of images in different angles to create three dimensional images or videos. However, current image processing applications fail to mimic a sequential sketching/painting process of the human artist for sketching/painting an artistic sketch of an image as these applications do not have intelligence in deciding priority order of steps in the sequential sketching/painting process.

### SUMMARY OF THE INVENTION

An aspect of an embodiment of the present invention is to provide a method for allowing a user to create a sketched image from a single input image, depict a sketching process, and save the sketching process as a video file.

In accordance with an aspect of the present invention, there is provided a method for sketching and painting in a mobile terminal, including detecting, when an image for sketching is selected, edges of the selected image, determining a type of a sketch mode and depicting a sketching process with the detected edges to correspond to the determined type of the sketch mode, and determining, upon a painting request for an image sketched through the sketching process, a painting mode and painting the sketched image to correspond to the determined painting mode.

### BRIEF DESCRIPTION OF THE DRAWINGS

The above and other aspects, features and advantages of embodiments of the present invention will be more apparent from the following description taken in conjunction with the accompanying drawings, in which:

FIG. 1 is a block diagram illustrating an image processing device for creating a live artistic sketch from an input image and filling non-photo realistic colors in the artistic sketch, according to an embodiment;

FIG. 2 is a flowchart illustrating a method of creating an artistic sketch from an input image and filling non-photo realistic colors in the artistic sketch, according to an embodiment;

FIGS. 3A-3B are flowcharts illustrating a method of creating a live artistic sketch of an input image, according to an embodiment;

FIG. 4 is a flowchart illustrating a method of painting the artistic sketch of the input image with non-photo realistic colors, according to one embodiment;

FIGS. 5A-5B are flowcharts illustrating a method of automatically filling the artistic sketch of the input image with non-photo realistic colors, according to an embodiment;

FIG. 6 is a flowchart illustrating a method of filling non-photo realistic colors in one or more regions in the artistic sketch revealed by a user, according to another embodiment;

FIG. 7 is a flowchart illustrating a method of filling user defined colors in one or more regions of the artistic sketch, according to yet another embodiment;

FIG. 8 is a schematic flow diagram illustrating a process of creating an artistic sketch of an input image, according to an embodiment; and

FIG. 9 is a schematic flow diagram illustrating a process of painting the artistic sketch of the input image, according to one embodiment.

The drawings described herein are for illustration purposes only and are not intended to limit the scope of the present disclosure in any way.

### DETAILED DESCRIPTION OF EMBODIMENTS OF THE INVENTION

The present invention provides a method and apparatus for creating a live artistic sketch of an image. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The term ‘artistic sketch’ refers to a freehand drawing created by an image processing device from an image.

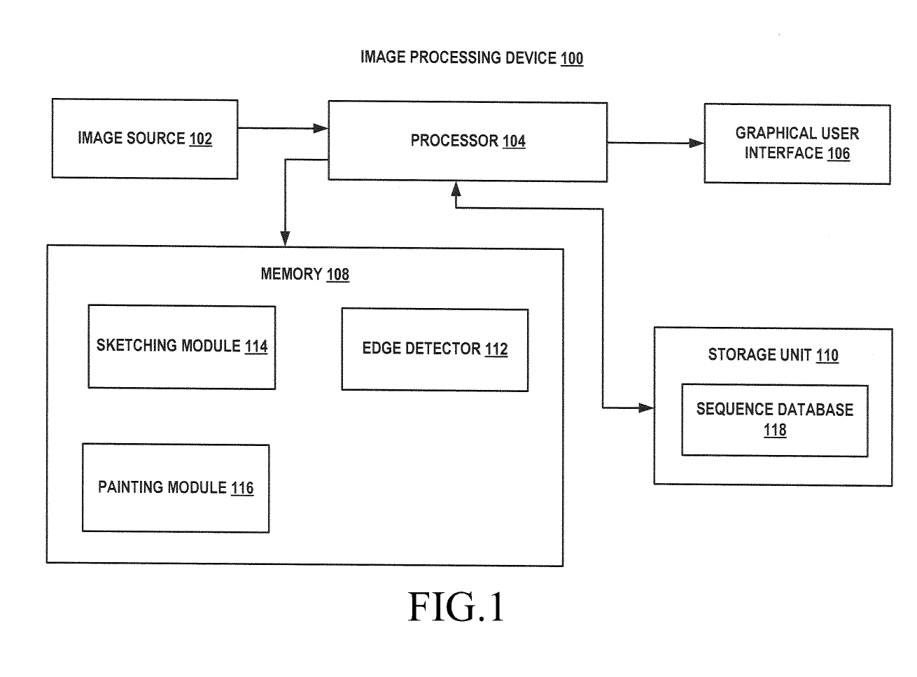

FIG. 1 is a block diagram illustrating an image processing device 100 for creating a live artistic sketch from an input image and filling non-photo realistic colors in the artistic sketch, according to one embodiment. In FIG. 1, the image processing device 100 includes an image source 102, a processor 104, a graphical user interface 106, a memory 108, and a storage unit 110. The memory 108 includes an edge detector 112, a sketching module 114, and a painting module 116. The image source 102, the graphical user interface 106, the memory 108, and the storage unit 110 are communicatively coupled to the processor 104.

The image source 102 inputs an image for creating an artistic sketch of the input image. In one embodiment, the image source 102 inputs an image file or an image captured by a camera. The edge detector 112 detects a plurality of edges in the input image. In one embodiment, the edge detector 112 is based on a minimum filtered negative edge detection algorithm which replaces every pixel at the centre of the filter span by a minimum valued negative of all pixels in the given filter span. This procedure is repeated for all pixels in the input image to create a minimum filtered negative image. The edge detector 112 detects edges in the input image by blending each pixel in the input image with corresponding pixel in the minimum filtered negative image using dodge blending technique.

The sketching module 114 connects each of the edges with one or more of remaining edges in a pre-defined neighborhood of said each of the edges. Then, the sketching module 114 determines one or more features associated with said each of the connected edges in the input image. These features include a spatial location, neighborhood zone, category, and/or pixel value. Thus, the sketching module 114 generates a sequence database 118 containing pixel information associated with each of the connected edges and feature information associated with each of the connected edges and stores the sequence database 118 in the storage unit 110. Accordingly, the sketching module 114 creates an artistic sketch of the input image in a pre-defined sequence using the feature information and the pixel information in the sequence database 118. In the case of a manual sketching process, the sketching module 114 creates a preliminary outline sketch by drawing prominent edges in the input image. In this process, the user is allowed to reveal/erase finer edges by touching the graphical user interface 106.

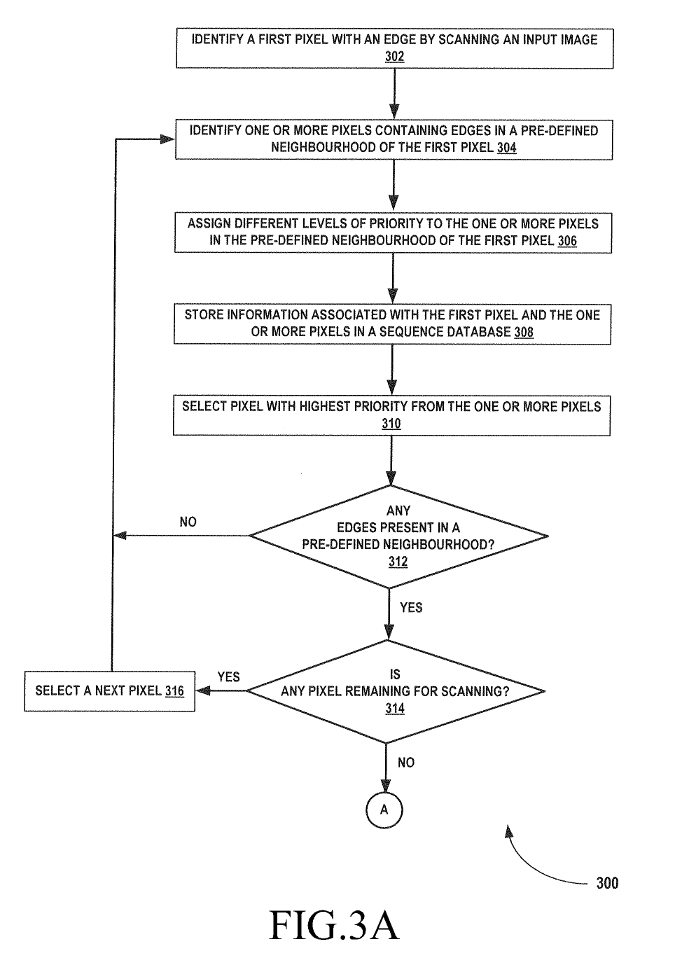

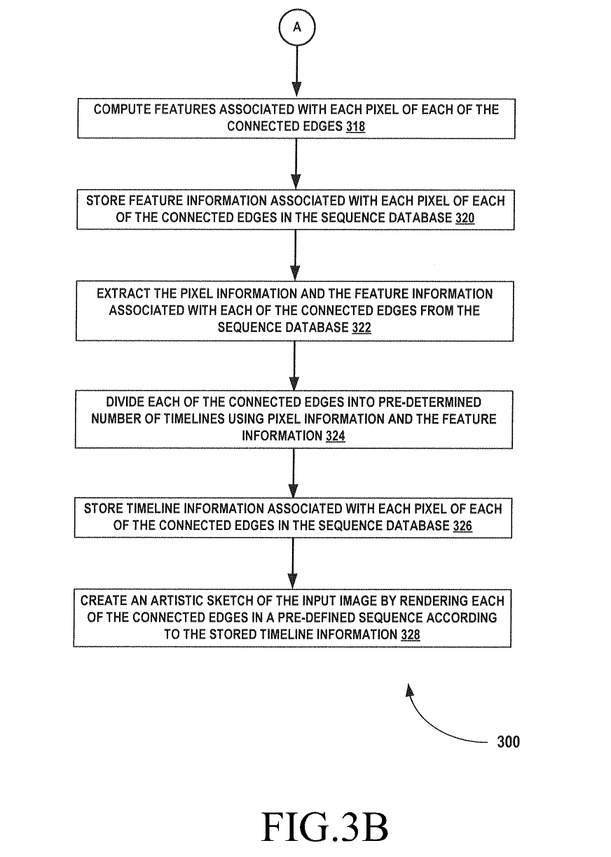

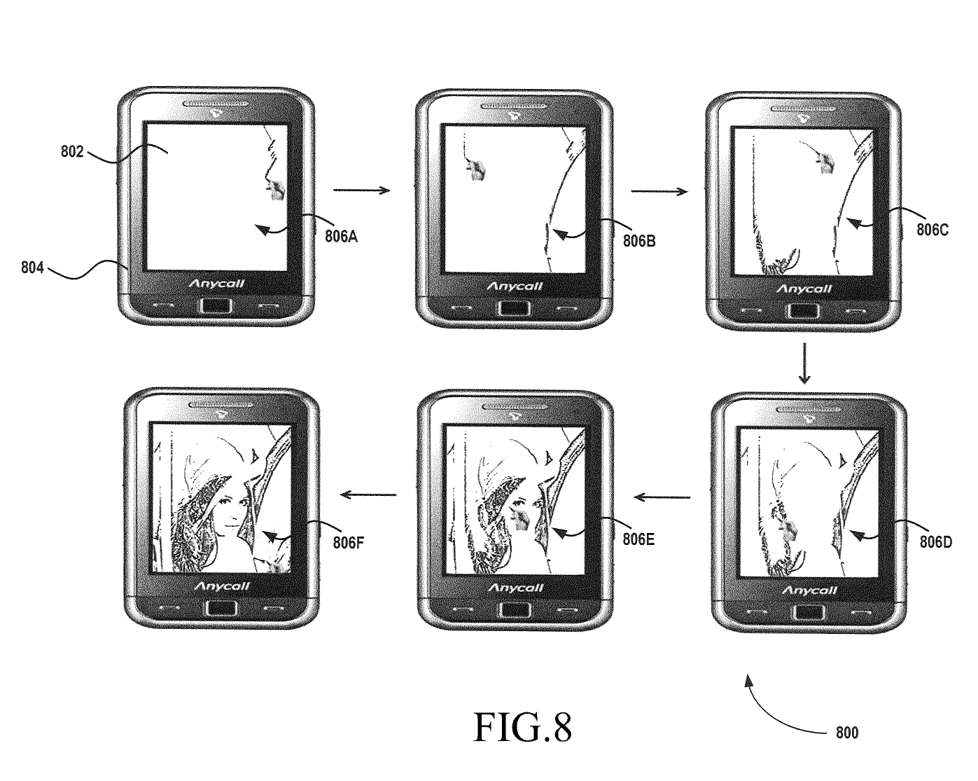

The graphical user interface 106 renders the artistic sketch of the input image substantially simultaneously with creation of the artistic sketch. Additionally, the sketching module 114 enables the user to store the artistic sketch of the input image in an image file format. Also, the sketching module 114 outputs a video file containing frames associated with creation of the artistic sketch in a multiple video file formats such as those shown in FIG. 8. The detailed process steps performed by the sketching module 114 will be described in FIGS. 3A-3B.

The painting module 116 enables the user to paint the artistic sketch using an automatic paint option or a manual paint option. If the user selects automatic paint option, the painting module 116 fills the artistic sketch with non-photo realistic colors to produce the effect of a painting. Accordingly, the graphical user interface 106 renders the act of filling the artistic sketch with the non-photo realistic colors while the painting module 116 fills the artistic sketch with the non-photo realistic colors. If the user selects the manual paint option, the painting module 116 fills user specified regions in the artistic sketch with non-photo realistic colors. Alternatively, the painting module 116 fills user specified regions in the artistic sketch using one or more colors selected by the user from a color palette.

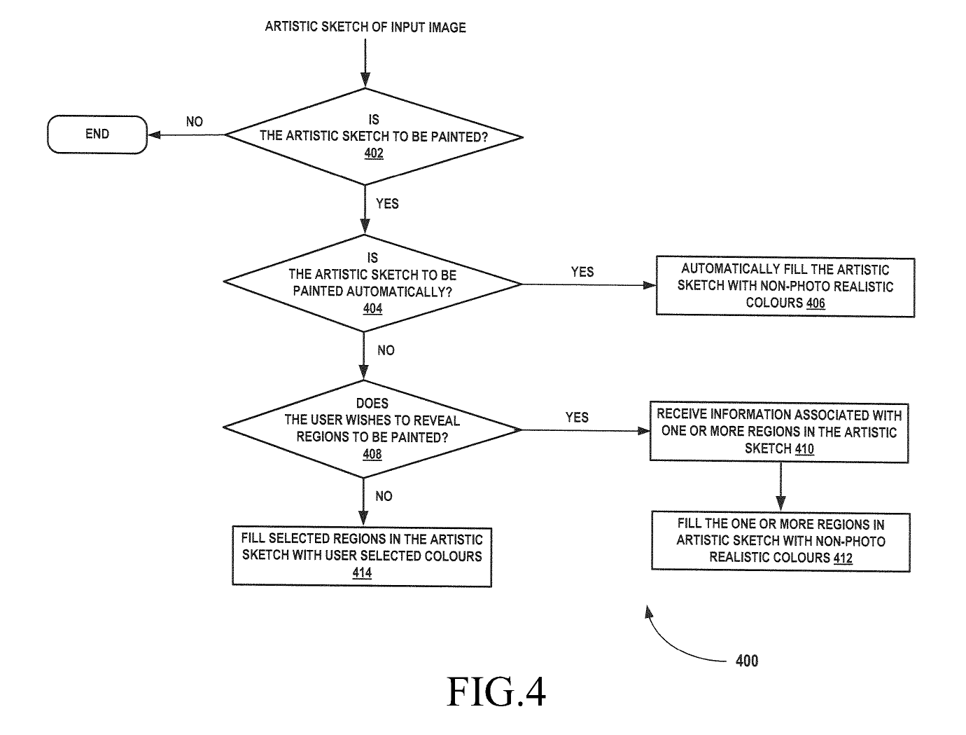

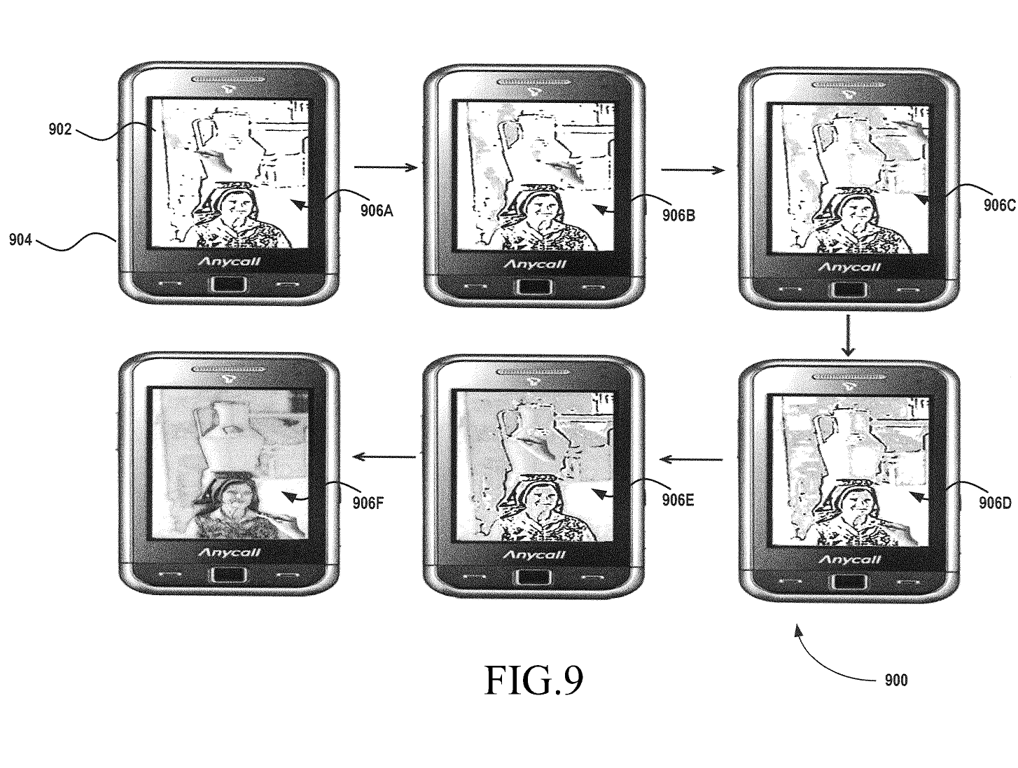

Additionally, the painting module 116 enables the user to store the artistic sketch filled with the non-photo realistic colors in an image file format. Also, the painting module 116 outputs a video file containing frames associated with filling the artistic sketch with the non-photo realistic colors in a multiple video file formats such as those shown in FIG. 9. The detailed process steps performed by the sketching module 114 will be described in FIGS. 4 through 7. In the manner described above, the image processing device 100 displays process of creating an artistic sketch of an image and painting the artistic sketch with non-photo realistic colors closely mimicking sketching process followed by an artist.

In accordance with the foregoing description, the edge detector 112, the sketching module 114 and the painting module 116 may be stored in the memory 108 in the form of machine readable instructions, which when executed by the processor 104, cause the processor 104 to performs functionality of the edge detector 112, the sketching module 114 and the painting module 116.

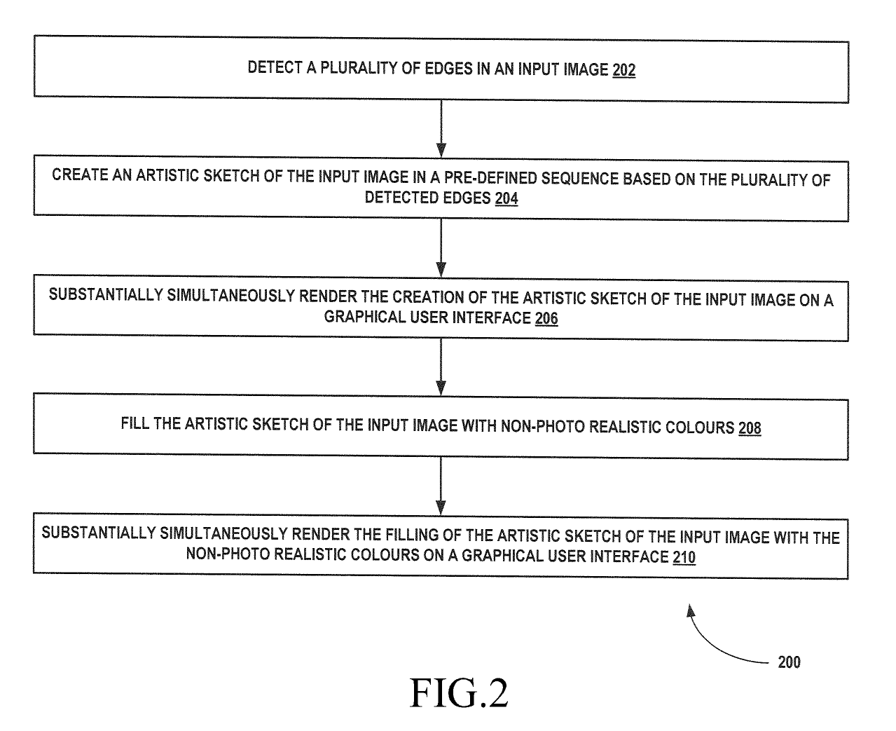

FIG. 2 is a flowchart 200 illustrating a method of creating an artistic sketch from an input image and filling non-photo realistic colors in the artistic sketch, according to one embodiment. At step 202, a plurality of edges is detected in an input image received from an input source. At step 204, an artistic sketch of the input image is created in a pre-defined sequence based on the detected edges. The detailed process steps of creating an artistic sketch will be described in FIGS. 3a-3b. At step 206, creation of the artistic sketch of the input image is substantially simultaneously rendered on the graphical user 106. In one embodiment, the artistic sketch of the input image is stored in an image file format. In alternate embodiment, a video file containing one or more frames associated with the creation of the artistic sketch is generated and stored in the storage unit 110.

Further if the user wishes to fill non-photo realistic colors in the artistic sketch, then at step 208, the artistic sketch of the input image is painted with non-photo realistic colors. The detailed process steps of painting the artistic sketch will be described in FIGS. 4 through 7. At step 210, painting of the artistic sketch is substantially simultaneously rendered on the graphical user 106. In one embodiment, the artistic sketch filled with the non-photo realistic colors is stored in an image file format. In alternate embodiment, a video file containing one or more frames associated with the filling the artistic sketch with the non-photo realistic colors is generated and stored in the storage unit 110.

FIGS. 3A-3B are flowcharts 300 illustrating a method of creating a live artistic sketch of an input image, according to one embodiment. At step 302, a first pixel with an edge is identified by scanning the input image with the detected edges. In one embodiment, for each pixel where an edge is detected, a pre-defined neighborhood surrounding said each pixel is scanned to identify presence of other edges in the pre-defined neighborhood. At step 304, one or more pixels containing edges in a pre-defined neighborhood of the first pixel are identified by scanning the pre-defined neighborhood of the first pixel.

At step 306, a different level of priority is assigned to the one or more pixels in the pre-defined neighborhood of the first pixel. It can be noted that, each of the one or more pixels have different level of priority and hence the edge to which said each pixel belongs also have different level of priority. At step 308, information associated with the first pixel and the one or more pixels in the neighborhood of the first pixel is stored in the sequence database 118. At step 310, the pixel belonging to the edge with highest priority is selected from the one or more pixels in the pre-defined neighborhood of the first pixel.

At step 312, it is checked whether any edges are detected in a pre-defined neighborhood of the selected pixel with highest priority. If one or more edges are detected in the pre-defined neighborhood, then step 304 through 312 are repeated. If there are no edges found in the pre-defined neighborhood of the selected pixel, then at step 314, it is determined whether all of the one or more pixels are covered. If there are pixels remaining for processing, then at step 316, a next pixel containing an edge in the decreasing order of priority is selected from the remaining pixels and steps 304 through 312 are repeated for the selected pixel.

If no pixels are left for processing, then step 318 is performed. Thus, at the end of step 316, pixel information indicating connection between one or more edges in the neighborhood of each of the detected edges (hereinafter referred to as connected edges) is obtained. The pixel information associated with the stored in the sequence database 118 at step 308. Further, at step 318, features associated with each pixel of said each of the connected edges are computed. The features associated with each connected edge include spatial location, neighborhood zone, category, and pixel value. At step 320, the feature information associated with each connected edge is stored in the sequence database 118. At step 322, the pixel information and the feature information associated with each of the connected edges is extracted from the sequence database 118.

At step 324, each of the connected edges is divided into a pre-determined number of timelines using the pixel information and the feature information. In one embodiment, the pre-determined number of timelines is determined based on a frame rate at which creation of the artistic sketch of the input image is to be rendered on the graphical user interface 106. At step 326, the time information associated with said each of the connected edges is stored in the sequence database 118. At step 328, an artistic sketch of the input image is created by rendering each of the connected edges in a pre-defined sequence according to the stored timeline information associated with said each of the connected edges. In this manner, the image processing device 100 creates a sketch of an image in a same manner as a human artist would create a sketch. Once the artistic sketch is created, a user is enabled to preview the artistic sketch and to play a video of creation of the artistic sketch in a sequential manner.

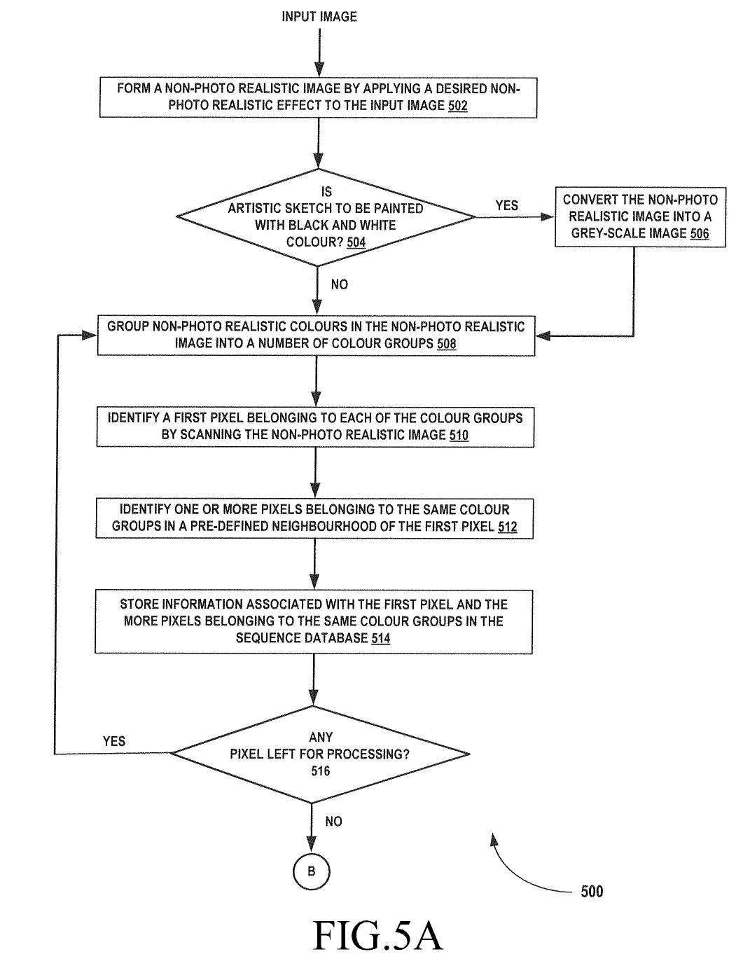

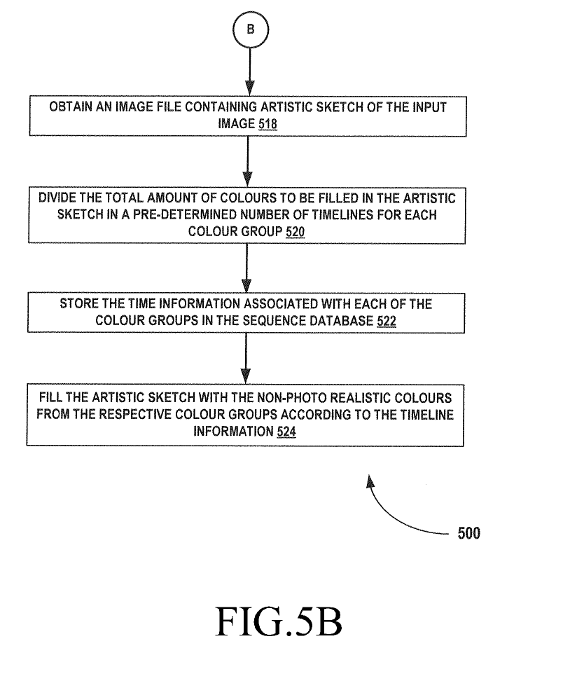

FIG. 4 is a flowchart 400 illustrating a method of painting the artistic sketch of the input image with non-photo realistic colors, according to one embodiment. Once the artistic sketch is ready, a user is queried as whether the artistic sketch is to be filled with non-photo realistic colors, at step 402. If the user wishes to paint the artistic sketch, then at step 404, it is determined whether the artistic sketch is to be painted automatically. If the artistic sketch is to be painted automatically, then at step 406, the artistic sketch is automatically filled with non-photo realistic colors. The detailed process of automatically filling the non-photo realistic colors in the artistic sketch will be described in greater detail in FIGS. 5A-5B.

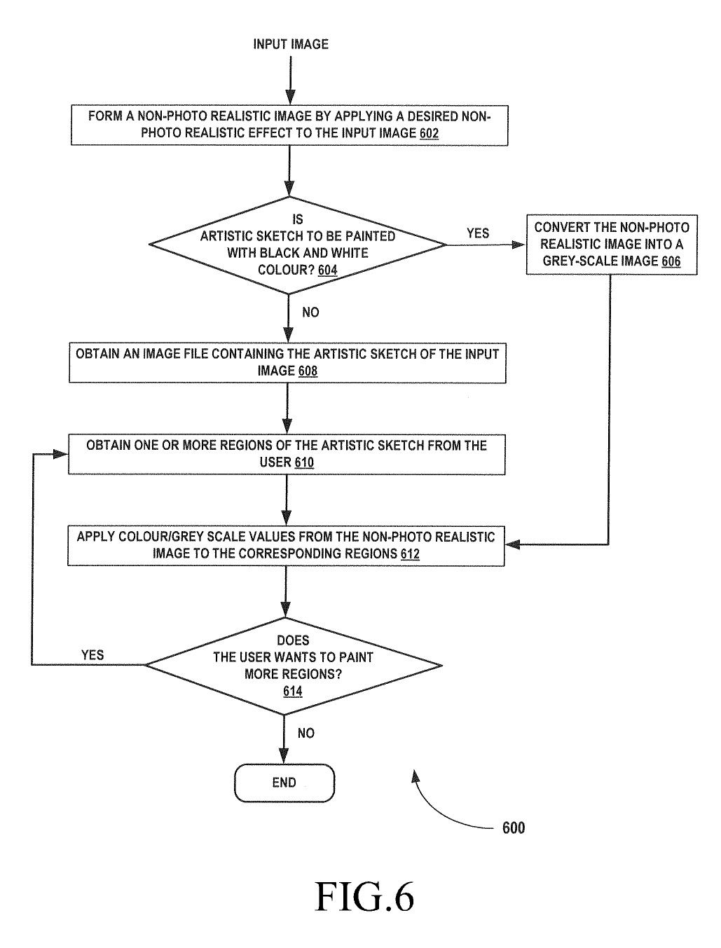

If the determination at step 404 is false, then at step 408 it is determined whether the user prefers a reveal option or a color fill option. If the user prefers a reveal option, then at step 410, information associated with one or more regions in the artistic sketch to be filled with non-photo realistic colors is received from the user. The user can reveal the one or more regions by scratching over the graphical user interface (e.g., touch screen display). At step 412, the one or more regions revealed by the user are filled with non-photo realistic colors. The detailed process of filling the non-photo realistic colors in the one or more regions revealed by the user will be described in greater detail in FIG. 6.

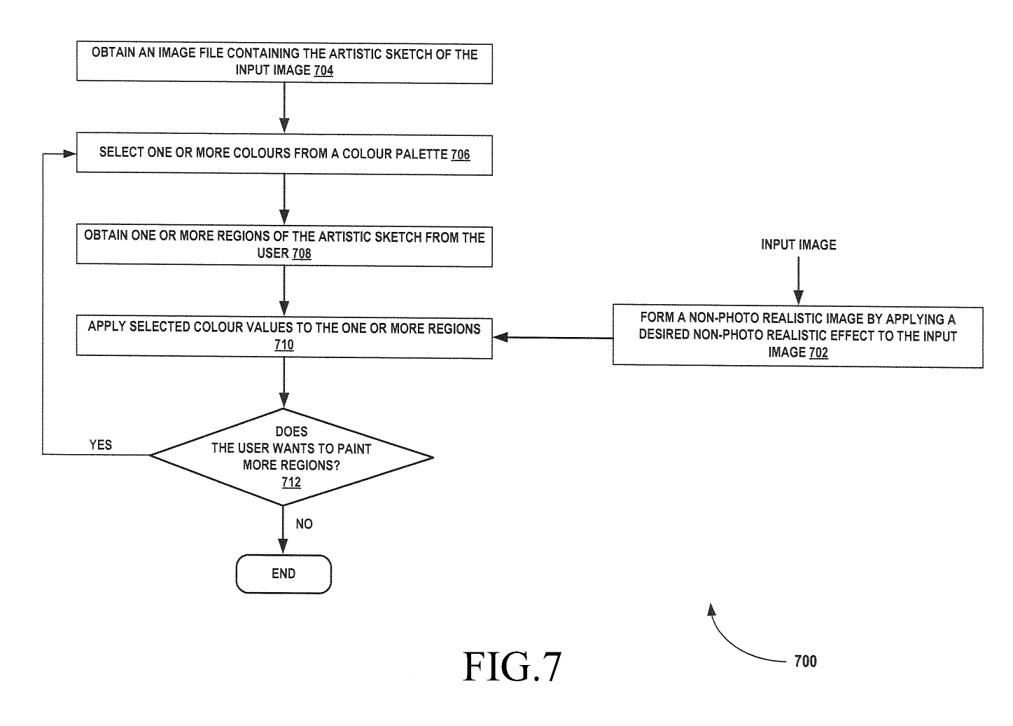

If the user selects a color option, then at step 414, non-photo realistic colors selected by the user is filled in tapped points in the artistic sketch. The detailed process of filling user selected non-photo realistic colors in tapped points of the artistic sketch will be described in greater detail in FIG. 7.

FIGS. 5A-5B are flowcharts 500 illustrating a method of automatically filling the artistic sketch of the input image with non-photo realistic colors, according to one embodiment. At step 502, a non-photo realistic image is formed by applying a desired non-photo realistic effect to the input image. For example, the non-photo realistic effect may include oil paint effect, water color effect, etc. At step 504, it is determined whether the user wishes to fill the artistic sketch with black and white color. If the user wishes to fill the artistic sketch with the black and white color, then at step 506, the non-photo realistic image is converted into a grey scale image and the step 508 is performed.

At step 508, non-photo realistic colors in the non-photo realistic image are grouped into a number of color groups. At step 510, a first pixel belonging to each of the color groups is identified by scanning the non-photo realistic image. At step 512, one or more pixels belonging to same color group in a pre-defined neighborhood of the first pixel are identified by scanning the non-photo realistic image. At step 514, information associated with the first pixel and the one or more pixels in the neighborhood of the first pixel and belonging to the respective color groups is stored in the sequence database 118. At step 516, it is determined whether any pixel is left for processing in the non-photo realistic image.

If any pixels are left for processing, the steps 508 through 516 are repeated. If no pixels are left for processing, then at step 518, an image file containing artistic sketch of the input image is obtained. At step 520, total amount colors to be filled in the artistic sketch are divided into a pre-determined number of timelines for each of the color groups based on the pixels belonging to the respective color groups. In one embodiment, the pre-determined number of timelines for filling the color is determined based on a frame rate at which frames associated with filling color has to be displayed. At step 522, the timeline information associated with each of the color groups is stored in the sequence database 118. At step 524, the artistic sketch is filled with the non-photo realistic colors according to the pre-determined number of timelines associated with each of the color groups.

FIG. 6 is a flowchart 600 illustrating a method of filling non-photo realistic colors in one or more regions in the artistic sketch revealed by the user, according to another embodiment. At step 602, a non-photo realistic image is formed by applying a desired non-photo realistic effect to the input image. At step 604, it is determined whether the user wishes to fill the artistic sketch with black and white color. If the user wishes to fill the artistic sketch with the black and white color, then at step 606, the non-photo realistic image is converted into a grey scale image and the step 612 is performed.

At step 608, an image file containing the artistic sketch of the input image is obtained. At step 610, one or more regions of the artistic sketch revealed by the user are obtained from the user. At step 612, the color/grey scale values from the non-photo realistic image are applied to corresponding regions revealed by the user in the artistic sketch. It can be noted that, amount of color to be filled in one or more regions is divided into timelines based on a frame rate and timeline information is stored in the sequence database 118. At step 614, it is determined whether the user wishes to paint any other regions in the artistic sketch. If the determination is true, steps 610 through 614 are performed, else the process 600 is terminated.

FIG. 7 is a flowchart 700 illustrating a method of filling user defined colors in one or more regions of the artistic sketch, according to yet another embodiment. At step 702, a non-photo realistic image is formed by applying a desired non-photo realistic effect to the input image and step 710 is performed.

At step 704, an image file containing the artistic sketch of the input image is obtained. At step 706, one or more colors are selected from a color palette. At step 708, one or more regions of the artistic sketch are obtained from the user. At step 710, the colors selected by the user are applied to corresponding regions in the artistic sketch. For example, one or more colors are applied to one or more regions upon tapping a point in the artistic sketch on the graphical user interface 106. It can be noted that, amount of color to be filled in one or more regions is divided into timelines based on a frame rate and timeline information is stored in the sequence database 118. At step 712, it is determined whether the user wishes to paint any other regions in the artistic sketch. If the determination is true, steps 706 through 712 are performed, else the process 700 is terminated.

FIG. 8 is a schematic flow diagram 800 illustrating a process of creating an artistic sketch of an input image per frame basis, according to one embodiment. Particularly, screenshot views 806A-F shows a graphical user interface 804 of a mobile device 802. The screenshot views 806A through 806F illustrate various frames of a video playing a process of sketching an input image in a pre-defined sequence similar to a human artist.

FIG. 9 is a schematic flow diagram 900 illustrating a process of painting the artistic sketch of the input image per frame basis, according to one embodiment. Particularly, screenshot views 906A-F shows a graphical user interface 904 of a mobile device 902. The screenshot views 906A through 906F illustrate various frames of a video playing a process of painting the artistic sketch of the input image similar to painting sequence followed by a human artist.

The present embodiments have been described with reference to specific example embodiments, it will be evident that various modifications and changes may be made to these embodiments without departing from the broader spirit and scope of the various embodiments. Furthermore, the various devices, modules, detectors, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

While the invention has been shown and described with reference to embodiments thereof, it will be understood by those skilled in the art that various changes in form and details may be made therein without departing from the spirit and scope of the invention as defined by the appended claims and their equivalents.

What is claimed is:

1. A method for sketching and painting in a mobile terminal, comprising:
detecting, when an image for sketching is selected, edges of the selected image;
determining a type of a sketch mode and depicting a sketching process with the detected edges to correspond to the determined type of the sketch mode; and
determining, when a painting request is received for an image sketched through the sketching process, a painting mode and painting the sketched image to correspond to the determined painting mode.

2. The method of claim 1, wherein the sketch mode includes an automatic mode, in which the sketching process with the detected edges is automatically performed without user intervention.

3. The method of claim 1, wherein the sketch mode includes a manual mode, in which edges by a user input are drawn after sketching is automatically performed with the most prominent edges among the detected edges.

4. The method of claim 3, further comprising erasing unwanted edges from the sketch.

5. The method of claim 1, wherein the edges are detected by a special minimum filtered negative edge detection algorithm.

6. The method of claim 1, wherein detecting the edges comprises:
scanning the edge-detected image using an algorithm; and
selecting a highest-priority pixel around each edge-detected pixel as a part of the edge, and connecting all of the edges.

7. The method of claim 6, wherein the algorithm includes a priority-based-neighboring-pixels-edge-presence algorithm.

8. The method of claim 1, wherein when the painting mode is an automatic mode, the painting comprises:
creating a non-photo realistic image from the sketched image;
converting, when color painting or black/white painting is selected by a user, the created non-photo realistic image according to the selection;
dividing the converted non-photo realistic color image into a plurality of color groups, searching for pixels belonging to each color group, and completing a sketch database; and
dividing each color group into timelines based on a frame rate, and filling colors according to the timelines.

9. The method of claim 1, wherein when the painting mode is a reveal mode among user-defined modes, the painting comprises:
creating a non-photo realistic image from the sketched image;
converting, when color painting or black/white painting is selected by a user, the created non-photo realistic image according to the selection;
receiving a user input for a specific region on a display screen on which the converted non-photo realistic color image is displayed; and
displaying edges on the non-photo realistic color image in a location corresponding to user input by releasing application of a non-photo realistic effect.

10. The method of claim 1, wherein when the painting mode is a color fill mode among user-defined modes, the painting comprises:
creating a non-photo realistic image from the sketched image;
selecting, by a user, a color provided through a color palette, and selecting a specific region on a display screen on which the non-photo realistic color image is displayed; and
filling the selected region with the selected color.

11. The method of claim 8, wherein the non-photo realistic color image is an image to which a non-photo realistic effect is applied; and
wherein the non-photo realistic effect includes at least one of an oil paint effect and a watercolor effect.

12. The method of claim 1, further comprising saving an image or video in a designated save format upon a save request for an image for which painting has been completed through the paining process.

13. The method of claim 12, wherein the save format includes at least one of 3 gp and Adobe Flash®.
